(19) United States
(12) Patent Application Publication
(10) Pub. No.: US 2009/0266999 A1
(43) Pub. Date: Oct. 29, 2009

(54) Apparatus and method for fluorescent imaging

(76) Inventor: Beat Krattiger, Beringen (CH)

Correspondence Address: ST. ONGE STEWARD JOHNSTON & REENS, LLC, 986 BEDFORD STREET, STAMFORD, CT, 06905-5619, US

(21) Appl. No.: 12/421,254

(22) Filed: Apr. 9, 2009

(30) Foreign Application Priority Data
Apr. 11, 2008 (DE) 102008018637.6-51
Apr. 3, 2009 (EP) 09004957

(51) Int. Cl. G01N 21/64

(52) U.S. Cl. 250/459.1; 250/458.1; 250/216

(57) ABSTRACT

An apparatus and method for fluorescent imaging. The apparatus includes a light-generating means for generating at least one modulated fluorescence excitation beam, a light retransmitting means for retransmitting the fluorescence excitation beam onto an area that is to be examined, a light-imaging means for imaging a fluorescent beam from the area to be examined onto a first image sensor, a control and evaluation means for controlling the light-generating means to power the first image sensor and for evaluating the data supplied by the first image sensor to generate a fluorescent image, where the fluorescent excitation beam may be continuously modulated, the first image sensor is a solid state detector that may be powered phase-sensitively, and the data supplied by the first image sensor contain pixel by pixel phase information on the fluorescent beam.

### CROSS-REFERENCE TO RELATED APPLICATIONS

The present application claims priority of German Patent application No. 10 2008 018 637.6-51 filed on Apr. 11, 2008 and of European patent application No. 09004957 filed on Apr. 3, 2009.

### FIELD OF THE INVENTION

The present invention relates to an apparatus and method for fluorescent imaging.

### BACKGROUND OF THE INVENTION

Apparatuses and methods for fluorescent imaging are known in the art. For instance, WO97/11636 discloses an apparatus for diagnosis by means of a reaction caused by a photo-sensitizer or by auto-fluorescence in biological tissue, in which a lighting system for generating a fluorescence excitation light is provided as well as a light-supply unit for illuminating a tissue area that is to be examined with the fluorescent stimulating light. Light coming from the tissue area can be absorbed by an endoscope lens and can be projected in a proximal image plane in which, for instance, the image-absorbing unit can be situated in a video camera. By using appropriate filters, an image of the fluorescent intensity can be generated in this manner in the particular tissue area and can be displayed, for instance, on a video screen.

Such a fluorescent image makes it possible to determine the distribution and activity of fluorescent materials in the tissue. Because these depend very acutely on the metabolism and the environment of the bodily cells, the measuring of the fluorescent radiation makes it possible to demonstrate tissue modifications that are not recognizable, or not yet recognizable, by observing the reflected light. Malignant tissue modifications or tumors, in particular, can be recognized in this manner at an early stage. The fluorescent materials here can be materials inherent to the body (autofluorophores), which are present naturally in the bodily tissue. Yet it is also possible to supply fluorescent materials for the diagnosis, or to supply materials from which the fluorescent materials arise. Such a photosensitizer, for instance, is 5-amino levulinic acid (5-ALA); a medicine based on 5-ALA is sold by the company GE Healthcare by the name of HEX-VIX(R). From metabolic processes that take place in practically all bodily cells, 5-ALA gives rise to photoporphyric IX (PpIX) that is capable of fluorescence and can be stimulated with an excitable radiation in the range of 405 nm for fluorescence to about 635 nm, said radiation being examined during a fluorescent diagnosis. Because these metabolic processes depend on the type, the condition, and the surroundings of cells, the fluorescence makes it possible to draw conclusions about the condition of the tissue and to recognize degenerate tissue.

According to patent WO97/11636, for better orientation and for greater contrast in visualizing, it is possible in addition to fluorescent radiation, for a portion of the reflected illuminating light to be absorbed by a detector and displayed on a video screen. Under this process, the spectral qualities of the components must be tuned to one another in such a way that the much higher excitation light does not over-radiate the fluorescence in the displayed image.

In the meantime, observation of fluorescent radiation as autofluorescence (AF) or photodynamic diagnosis (PDD) has assumed considerable importance in medical diagnostics. Such a system for endoscopic autofluorescence diagnosis of bronchial illnesses is provided, for instance, by the KARL STORZ Company (see company publication “Autofluoreszenz-Brochoskopie,” EndoGramm Thor 1-1-D/11-2005).

Fluorescent radiation emitted by a fluorescent material is distinguished from reflected or scattered radiation by the time span that elapses until one or more photons of the fluorescent radiation are emitted after absorption of one or more photons of the excitation light. For many fluorescent materials existing in the biological tissue or generated by photosensitizers, this time span is in the nanosecond (ns) range. In recent years, systems have been developed for demonstrating the time delay in fluorescent radiation. Because the time delay is related to the lifetime of the corresponding excited condition of the fluorescent material, reference is made to lifetime measurements. Locally triggered imaging of the time delay or fluorescence lifetime is generally referred to as “fluorescence lifetime imaging” (FLIM).

European patent, EP 1746410 A1, discloses a microscopic apparatus in which an object is illuminated with high frequency modulated radiation and is observed with a phase-sensitive solid-state detector that includes a number of pixels. The detector makes possible the pixel-by-pixel phase-selective storage of charge carriers that are released by the impinging radiation and the pixel-by-pixel read back of stored charges. Because of a corresponding evaluation of the charge value to be ascribed to the various phases of the incident signal, a pixel-by-pixel determination of the phase difference between the received signal and the light radiation becomes possible, which in turn is a measure of the fluorescence lifetime.

The fluorescence stimulus radiation is focused in the object plane by a microscope objective, and the fluorescence radiation is observed by the same microscope objective.

An article by Elson et al., in Annual Review, In Fluorescence 2006, pp. 1-50, describes an endoscopic system for fluorescent imaging in which a pulsed excitation beam is emitted from a light source and is conducted by a light conducting fiber onto a tissue area that is to be examined. The fluorescent beam emitted from the tissue area is imaged by the eyepiece of an endoscope lens onto the photo cathode of a gated optical image intensifier (GOI). The number of charge carriers that are counted in a time window with a predetermined delay with respect to the pulses of the excitation radiation and which are generated by the incident fluorescent radiation is available pixel by pixel for generating an image of the fluorescence lifetime.

To prevent the pulses from diverging, a diode-pumped Nd:YVO4 laser is used which comprises very low divergence and whose energy is injected into low modes of a light conductor fiber with particularly low group speed dispersion. A GOI requires a stable mechanical mounting, complex electronics, high voltages and is not suited for an endoscope during an endoscopic procedure.

An article by Wagnières et al., Frequency-domain Fluorescence Lifetime Imaging for Endoscopic Clinical Cancer Photodetection: Apparatus Design and Preliminary Results, Journal of Fluorescence, Vol. 7, No. 1, 1997, pp. 75-83, describes a trial model in which continuously modulated fluorescence excitation light is conducted onto a tissue area that is to be examined. The beam emitted from the tissue area is conducted by an endoscope lens onto two image reinforcers with a modulated reinforcement factor. The stationary image generated by these image reinforcers is absorbed by one CCD video camera in each case and evaluated to generate a fluorescence lifetime image. This model requires a very high instrumental complexity and is therefore not suited for routine clinical applications.

It is therefore the object of the present invention to provide an apparatus for fluorescent imaging which is appropriate for endoscopic application, for instance intraoperatively, while also being economical and easy to operate. The object of the present invention includes providing a corresponding method of fluorescent imaging. “Fluorescence” is understood here and in the following text to include other forms of luminescence, including in particular phosphorescence.

### SUMMARY OF THE INVENTION

Accordingly, it is an object of the present invention to provide an apparatus for fluorescent imaging, consisting of: a light-generating means for generating at least one modulated fluorescence excitation beam, a light retransmitting means for retransmitting the fluorescence excitation beam onto an area that is to be examined, so that the light retransmitting means comprise at least one illuminating lens that can be used endoscopically, a light imaging means for imaging a fluorescent beam from the area to be examined onto a first image sensor, which comprises a number of pixels, so that the light-imaging means comprise at least one imaging lens that can be used endoscopically, control and evaluation means for controlling the light-generating means, to power the first image sensor, and to evaluate data supplied by the first image sensor to generate a fluorescent image, wherein the fluorescence excitation beam can be continuously modulated, the first image sensor is a solid state detector, which can be powered phase-sensitively, the data supplied by the first image sensor contain phase information of the fluorescent beam pixel by pixel.

It is another object of the present invention to provide a method for fluorescent imaging comprising the following steps: generating at least one modulated fluorescence excitation beam, retransmitting the fluorescence excitation beam onto an area that is to be examined by at least one illuminating lens that can be employed endoscopically, imaging the fluorescent exitation beam from the area to be examined onto at least a first image sensor, which comprises a number of pixels, by at least one imaging lens that can be employed endoscopically generating of a fluorescent image through evaluation of the data supplied by the first image sensor, characterized in that the fluorescence excitation beam is continuously modulated, the first image sensor is a solid state detector that is powered phase-sensitively, the data supplied by the first image sensor contain pixel by pixel phase information on the fluorescent beam, from which a fluorescence lifetime image is generated.

The fluorescence excitation beam may be continuously modulated, and the first image sensor may be a solid state detector that can be powered by phase-sensitive means, while data provided by the first image sensor contain pixel-by-pixel phase information on the fluorescent beam. According to the invention, an endoscopically usable apparatus for fluorescent imaging is provided, which is economical and easy to operate. Continuous modulation of the fluorescence excitation beam may be achieved with relatively simple electronic means, and phase-sensitive solid state sensors are of simple construction, easy to operate, and available at moderate cost. With a corresponding modulation frequency, time delays that lie in the range of the lifetime of frequent fluorescent material may be demonstrated simply and securely. By means of pixel-triggered collection and evaluation of the phase information, it becomes possible to generate an image that depicts locally triggered fluorescence lifetime information. As a result, FLIM, for instance, may be made available for many diagnostic applications in clinical practice.

An inventive apparatus includes light-generating means for generating at least a modulated fluorescence excitation beam. To generate the modulated fluorescence excitation beam, it is possible to use, in particular, light-emitting diodes (LEDs), superluminescence diodes, lasers, in particular laser diodes, or other radiation sources that may be modulated in corresponding ways. If for this purpose a light source with intrinsically pulse-type output, for instance a supercontinuum laser, is used, the generated light pulses must be transformed into a continuous or continuously modulated beam, for instance by means of an optical pulse stretcher. As a result, the starting signal, which with supercontinuum white light lasers typically last less than about 10% of a period, may be extended to more than 50% or nearly 100%, where a sufficient modulation remains for applying the inventive method. Such a pulse stretcher may advantageously be realized if the excitation ray is injected into a multimode fiberglass, in particular a multimode-step-index-fiberglass, with a sufficiently high numeric aperture (NA) and as a result of the wavelength differences of beams with varying insertion angle, corresponding time delays and thus a pulse widening or pulse stretching results over a sufficient fiber length. Thus an NA of about 0.6, for instance, is sufficient to achieve the necessary pulse lengthening on the order of magnitude of 20 ns (nanoseconds) with a fiberglass length of about 40 m.

Here, laser diodes in particular have the advantage of ease of handling and are reasonably priced, compact, and easily modulated. Thus multimodal laser diodes as a rule have the advantage of a higher output capacity than monomodal laser diodes. According to the invention, laser diodes may be used with an intrinsic divergence well over 1 m rad, such as 0.1 rad, up to more than 0.9 rad.

The fluorescence excitation beam here may be continuously modulated, that is, over the entirety or at least an essential part of a modulation period, distinct from zero and/or variable in time. In particular, the fluorescence excitation beam may be continuously modulated periodically. Unlike in a pulse-type modulation, marked by steep sides and because it takes up only a small portion, such as 10%, or in particular less than 50%, of a period, the excitation beam here is intended to last for a major part of the period, and also the temporal derivative of the modulation signal is to lie preferably in the order of magnitude of that with a sinusoidal modulation. In particular, the intensity of the fluorescence excitation beam may be modulated in sinusoidal or quasi-sinusoidal shape, possibly over the ground line.

The generated beam contains, upon generation or after subsequent transformation, at least light of such a wavelength that is sufficient to excite at least one fluorescent material or fluorophor in an area that is to be examined. “Light” here is understood to mean not just visible light but also, for instance, an infrared or ultraviolet ray. For improved handling and more effective cooling, the light-generating means may be situated in a housing of its own or as a separate light source.

Moreover, an inventive apparatus includes light-retransmitting means for retransmitting the fluorescence excitation beam onto an area to be examined. The light-transmitting means here may be, in particular, means for injecting the beam generated by a light source into a light conductor as well as light conductors for retransmitting the beam. Thus a lens and/or mirror arrangement, for instance, for improved injection of the generated beam may be provided, or else fiber-coupled superluminescence or laser diodes may be used. According to the invention the injection may take place with a numeric aperture up to more than 0.25 rad, which allows the use of a number of current superluminescence or laser diodes. If the light-generating means are arranged in a separate housing or as separate light source, then, in particular, a light-conductor cable for retransmitting the beam may be provided that may be equipped with connecting means for connecting with the light source or other light conductors.

In addition, at least one endoscopically usable illuminating lens may be provided. Such an illuminating lens may be flexible, semi-rigid, or rigid and made of a light conductor fiber, a bundle of light conductor fibers, a light conductor rod or a different apparatus for light-retransmitting which may be inserted into a hollow cavity of an object or of a human or animal body. The light conductor fibers may in particular be multimode fibers. Means for distributing the beam onto the area to be examined may also be provided, such as a diffuser or an enlarging lens for uniform illumination of the object field, in particular on the distal end (close to the object) of the illuminating lens. In particular, if the beam is injected with a high numeric aperture or is retransmitted, the enlargement lens may be wholly or partly dispensed with.

To avoid the injection of undesired radiation, for instance to reduce the heat impact in an endoscopic application in a living body, filter means may also be provided that filter out particular portions of the generated radiation wholly or in part. Such filtering means may in particular also be advantageous for preventing absorption of undesired radiation from an image sensor and preventing its functioning or the predictive value of image it produces is adversely affected.

The inventive apparatus further includes light-imaging means for imaging a fluorescence beam from the area to be examined, at least onto a first image sensor, such that the light-imaging means include at least one endoscopically usable, flexible, semi-rigid, or rigid imaging lens. For this purpose, in particular, a lens arrangement, for instance an endoscope objective, may be provided. Said objective may generate an imaging onto an image sensor positioned close to the distal end of the imaging lens. It is also possible to provide image-retransmitting means, for instance a rod lens system or an image conductor made of light conductor fibers, in order to reconduct the image generated by the endoscope objective onto the proximal end (far from the object) of the imaging lens, where the imaging is conveyed on an image sensor. The light imaging means may further include filtering means in order to block out certain parts of the absorbed beam, for instance the fluorescence excitation beam, which may outshine the fluorescence signal.

The inventive apparatus further includes control means for controlling the light-generating means and for controlling the first image sensor, which is configured as a phase-sensitive powerable solid state sensor. In particular the control means make it possible to generate the modulation of the fluorescence excitation beam and accordingly to power the first image sensor to the phase-dissolved absorption of the received beam and to read the signal of the first image sensor.

Finally, according the invention evaluating means are included to evaluate data that is provided by the first image sensor, which includes a majority of pixels, and that contain pixel-by-pixel phase information concerning the modulation of the fluorescent beam, to generate a fluorescent image. Here conclusions may be drawn from the phase information about the time delay between the impinging of the fluorescence excitation beam and emission of the fluorescent beam, in order to generate an image that, for instance, gives a pixel-by-pixel depiction of this time delay that is linked to the fluorescence lifetime. By means of a comparative measurement, for instance, with non-fluorescent material, distancing and apparative effects may be distinguished from the time delay by fluorescence so that the fluorescence lifetime may be determined. Such an image, for instance, may be conveyed on a video screen.

The object of the invention is hereby completely achieved.

According to a preferred embodiment, the illuminating lens and the imaging lens may be positioned in a common endoscopically usable shaft. This shaft, depending on the configuration of the illuminating and imaging lenses, can likewise be flexible, semi-rigid, or rigid. This has the advantage that the inventive apparatus is easy to use in endoscopic applications and the shaft, in known manner, can be inserted through a natural or artificial body opening or else, for instance, through an inspection opening into an internal body cavity. Thus it can be advantageous, for reasons of handling, if the light-generating means are connected with the shaft as a compact unit. Light-generating means with low loss capacity and structural size, for instance superluminescence or laser diodes, are particularly suitable for this purpose.

In a preferred embodiment at least the first image sensor may be absorbed in a video camera arrangement that is dissolubly connected with the endoscopically usable shaft. In particular, the video camera arrangement may include a compact video camera unit with a housing that, for instance, may be connected easily and securely with the endoscope shaft by an endoscope coupling.

It was determined that in a continual, in particular a sinusoidal, modulation of the fluorescence excitation beam, any kind of group velocity dispersion into materials that are used for light retransmission has an effect likewise on the signal amplitude but not necessarily on the measured time delay or fluorescence lifetime. According to the invention, therefore, materials for instance with a non-disappearing group velocity dispersion and/or multimode fibers are used for the retransmission of the fluorescence excitation beam. Multimode fibers in addition are more favorable for transmitting light of incomplete coherence.

According to another preferred embodiment, the illuminating lens, the imaging lens, and the common endoscopically usable shaft therefore may be parts of a standard endoscope that may be a rigid, semi-rigid, or flexible endoscope. Such a standard endoscope may comprise an eyepiece for a direct view or else may be prepared for connecting a video camera unit by means of a C-mount.

This has the advantage that available endoscopes, such as those on hand in a clinic, may be used according to the invention for fluorescent imaging. Such endoscopes are available in a number of models for various human and veterinary purposes or for technical applications. Other components in the distal area, either fixed or dissolubly connected thereto, may be provided, including examples such as beam splitters, image sensors, and the like, which are specific for fluorescent imaging. In this case the application of other components of a standard endoscope at least allows for cost-effective production, especially through the use of materials with proven bio-compatibility, sterilizability, heat resistance, and other qualities.

In another preferred embodiment of the invention, at least the imaging lens and the first image sensor may be positioned inside an endoscopically usable shaft and close its distal end.

In addition, the illuminating lens close to the distal end, as well as other optical and electronic components, may be incorporated inside the shaft. This has the advantage that only electrical and/or light conductor cables are required to produce the connection between the distal and proximal ends of the shaft, thus making possible an especially simple, economical, and slender version of the shaft, especially a flexible shaft. In a preferred embodiment of the invention, at least the imaging lens and the first image sensor, but advantageously also other optical and electronic components, may be combined into a unit, in the manner of a removable objective, that may be separated from the other part of the shaft and endoscope. This has the further advantage that the endoscope may also be used for other types of applications such as fluorescent imaging.

Illuminating means of varying coherence may be used to generate the fluorescence excitation beam. With illumination with radiance of high coherence, the impinging image may be subject to speckles. They generate apparent structures in the illuminating strength and/or in the observed signal that may cover up the examined object.

According to a preferred embodiment of the invention, therefore, means may be provided for reducing the coherence in order to generate a uniform image. Thus, for instance, the illuminating means may be powered in such a way that the degree of coherence remains below a pre-established threshold or if speckles occur in the generated fluorescent image in considerable quantity, the degree of coherence is reduced. This may be achieved, for instance, with a laser diode by operating at or just below the laser threshold, or else the laser diode may be powered or modulated in such a way that the coherence of the emitted beam is lower.

In an inventive device for fluorescent imaging, an eyepiece may also be provided. Direct viewing through an eyepiece has the advantage that, even independently of the image generation by the phase-sensitive image sensor, it is possible to observe the area to be examined in order, for instance, to allow a physician in the customary manner to have a simple orientation in a body cavity or in the tissue area that is to be examined.

According to a preferred embodiment of the invention, one or more additional sensors may be available in addition to the phase-sensitive image sensor. These may be sensors for non-imaging analysis of the beam, or they may, in especially preferred manner, be additional image sensors. Such image sensors may be configured, for instance, as CCD or as other semiconductor image sensors, in particular as UV, IR, low light or other phase-sensitive image sensors.

The use of additional sensors makes it possible to gain further information from the observed area, such as spectral or intensity information. The use of additional image sensors has the particular advantage that at least one additional image is available to supplement the fluorescence lifetime image. As a result, for instance in a diagnostic application, it becomes possible to recognize structures that alone do not emerge at all, or not with sufficient clarity, in the fluorescence lifetime image, or to correlate the structures recognizable in the fluorescence lifetime image with structures that are recognizable with other imaging methods. Likewise, an image that corresponds to the visual impression, such as an x-ray image taken with one or more sensors, or an image in a restricted spectral range, may be recorded.

Another preferred embodiment provides for a beam splitter. This beam splitter serves to divide the absorbed beam into various observation beam paths or sensors. One or more semi-transparent mirrors in particular may be used as beam splitters, preferably in the form of partially reflected surfaces in image splitter prisms or image splitter cubes, where the semi-transparent mirrors may also be configured as dichroitic mirrors for spectrally selective image splitting. The use of semi-transparent mirrors has the advantage that information may be yielded by various observation beam paths at every moment.

Alternatively or additionally, means may also be provided for switching between various observation beam paths or sensors. These may be mechanical means, such as choppers, or else electrical means such as a mirror that may be electrically powered. The switching means may also be powerable synchronously with the light-generating means and/or with the phase-sensitive image sensor. Switching allows alternating use of different observation beam paths in advantageous manner.

According to an additional preferred embodiment of the invention, an adaptive lens may be provided for adjusting the visual fields of the first and at least one additional image sensor. For principle reasons or because of considerations of space or cost, use is made of image sensors having different formats, and this has the advantage that in some cases different sensor sizes or image diagonals and/or sensor formats do not result in visual fields of different size, but instead represent the different image data from the same area in each case. This is particularly advantageous if a simple visual comparison of the different image data is to be made possible by one user and is not to be restricted to the smallest visual field of the various sensors in each case.

The adaptive lens may be positioned between the beam splitter and at least one image sensor and thus may consist of an optical member or several and may, in particular, contain lens with negative and/or positive refractive power or corresponding mirror elements. As a result the image generated on one image sensor may be enlarged or reduced, so that it configures the same visual field as on one or more other image sensors. To adapt to various formats or aspect ratios of the image sensors, the adaptive lens may also contain astigmatic optical elements. The adaptive lens may also be configured together with an image splitter prism or cube as a compact block. An enlarging adaptive lens may also make possible a reduction of the beam splitter and thus a reduction in weight, volume, and cost.

For setting, focusing, and/or adjustment, the adaptive lens may also have a different configuration, for instance as a zoom lens. This is particularly advantageous if the first and/or the at least one other image sensor is configured as separable from a beam splitter or from an optical unit that comprises the beam splitter. In this case, on applying an image sensor, a new setting of the image plane and/or enlargement may be required. In particular if an image sensor is replaced with one of a different type, an adaptive lens may make possible the adaptation of the particular visual fields.

According to another preferred embodiment of the invention, an image sensor may be provided that is configured to generate an image of the observed area by means of the reflected or scattered light. Such an image has the advantage that, for instance in a diagnostic application, it displays the usual view of the tissue area that is to be diagnosed and thereby facilitates the orientation in the fluorescence lifetime image and the identification of the observed tissue area. To differentiate between reflected and scattered light, polarization-optical elements may also be provided.

According to an additional preferred embodiment of the invention, a spectrally dissolved or selected image of the observed area may be generated. For this purpose filters may be provided, for instance, which let pass only a particular spectral portion of the reflected or scattered light. An image that is dissolved spectrally into several parts or is selected according to one spectral part, allows a more contrasted depiction and thereby improves the security of a diagnosis.

In particular for the case of narrow-bandwidth spectrally selective imaging, a spectrally selective element such as a prism or a grid may be provided. An image of the observed area takes shape then through point or line scanning. This may result in a particularly high-contrast image.

According to another preferred embodiment, an image sensor may be provided for generating a fluorescence-intensity image. The other image sensor may be configured in particular as an image sensor for a PDD system in a manner that is known in itself. The generated PDD image here may also contain a portion of the reflected or scattered light. The fluorescence-intensity image is available as a complementary depiction of the same or of other fluorescent materials that are observed in the fluorescence lifetime image. An improved diagnosis may result, and in particular as a result the specificity of the diagnosis may be increased and, for instance, erroneously positive findings and thus probably unnecessary biopsies may be avoided.

According to another preferred embodiment of the invention, in addition to a fluorescence lifetime image, 3D data of the observed area may also be generated. This has the advantage that additional information may be obtained on the observed area that may serve to identify a tissue area, for instance, and for diagnosis.

In a particularly preferred manner, the 3D data may be obtained by means of the same phase-sensitive image sensor and with the same illumination and data evaluation. This requires only another filtering, which also allows the reflected or scattered light to pass. While the reflected or scattered fluorescence excitation light is disturbing for the fluorescent image and therefore is advantageously eliminated, it is used in obtaining distance or 3D data, so that the fluorescent light may be eliminated. Through an edge filter for instance, which is permeable only for a wavelength range that excited practically no fluorescence but still lies in the detection range of the sensor, such as in the red or NIR range, for instance at 800 nm, it is also possible to ensure that only light that may be used for the 3D data collection is beamed onto the object and reaches the sensor as reflected or scattered light.

Because the 3D data contain direct information on the time lapse between illumination and reflected or scattered signal, correction may hereby also be made for that portion of the time lapse between illumination and fluorescent signal that derives not from the fluorescence lifetime but from the distance of the fluorescent surface. As a result a more precise depiction of the fluorescence lifetime may be obtained.

According to another preferred embodiment, the 3D data may be evaluated for surface and/or volume measurement. The lateral extension of a structure may be ascertained from a fluorescence lifetime image or from another image of the observed area, with the help of distance information, and the depth extension of the structure may be obtained from the distance data. In this manner the measurement of surfaces and volumes is possible. This is in particularly advantageous in endoscopic applications, where depth information is not necessarily available. Both in inspecting technical components as in making medical diagnoses of tissue modifications, such measurements are desirable for determining the size and, in several measurements, the temporal change of structures such as fissures in technical components or lesions or tumors in human or animal organs. In particularly advantageous manner, the measurement of surfaces or volumes may be combined with fluorescent data from the fluorescence lifetime image or else from a fluorescent intensity image.

In another preferred embodiment of the invention, a stereo image may be synthesized from the 3D data. Such a stereo image may be depicted with an appropriate display device, which displays different images for both of an observer's eyes, and it provides the observer with a lifelike spatial impression of the observed area. This is particularly desirable in endoscopic operations to give the operator improved intuitive control of the instruments he or she operates.

The inventive device, according to a particularly preferred embodiment, may be configured in such a way that the image data provided by the first image sensor and at least one additional image sensor, or image data proved by a video camera connected to the eyepiece, may be depicted in a synoptic manner. Such a depiction may be a superimposed depiction of the particular image data or one depiction after another or a depiction in images arranged alongside one another. For the depiction for one user, corresponding display devices may be provided, such as one or more video screens, projectors, printers, and so on. Storage means for recording, documentation, and archiving of image data may likewise be provided. The control and evaluation means, in addition, may be configured for conducting image analysis processes that may be independent of the user or can be entered by the user. This may result, for instance, in emphasizing or reducing contrasts, smoothing the data, or else correlating image data with one another that have been supplied by various image sensors. Thus, information from a visual or x-ray image, from AF or PDD images, and/or a fluorescence lifetime image, for instance, may be combined with one another.

The control and evaluation apparatus may also be configured, through correlation of the image data of the various image sensors, to automatically produce a precisely located superimposition of the image data or else to conduct an automatic adjustment of the visual fields in terms of position size and/or format. It is also possible, in some cases independently of the sensor, to provide automatic focusing or automatic distortion correction.

According to another preferred embodiment of the invention, it may be possible to arrange not only to generate such a light as is suited for stimulating at least one fluorescent material and to retransmit it on to the area to be examined, but also at least one additional beam. It may be, for instance, white light for generating a white light image while observing through an eyepiece or by means of a corresponding additional image sensor, or else by means of the first image sensor in a corresponding mode of operation. For this purpose corresponding light-generating means may be available, such as a xenon or metal halide lamp for generating a white light illumination, which may be positioned in a light source of its own or in a common light source together with the light-generating means for the fluorescence excitation beam.

Likewise for generating a broadband illumination, fiber-pumped fluorescent light sources may be used such as are disclosed in US Patent Application No. 2007/0092184 A1, if they have sufficiently short fluorescence lifetimes. In the use of supercontinuum white light laser sources, there is an additional advantage that they may be modulated, at times synchronously with the phase-sensitive image sensor. In addition, supercontinuum white light fibers may radiate wavelength-selectively and may accordingly be powered electrically. Such a light source may suffice for generating all required types of beam.

To generate an image in reflected or scattered light, the fluorescence excitation beam itself may frequently be used; here it is possible to filter out the fluorescent beam by an appropriate filter, but as a rule the fluorescent beam is outshone by the reflected or scattered excitation beam, so that a corresponding filter is not necessary. It is also possible, in advantageous manner, a broadband, especially white-light illumination may be used for generating such an image, for instance by means of a xenon light source.

The additional ray may be generated simultaneously with the fluorescence excitation beam and retransmitted into the area to be examined or else may be generated or retransmitted reciprocally with the fluorescence exciting beam through corresponding powering and/or through an optical switching element. The latter is particularly advantageous when illumination with the particular beams is not necessary at all times, and in the other times it is possible to switch off or block off the respective beam that is not necessary, in order to reduce the injected energy amount. The switching frequency may be set in such a way that the switching is not perceptible any longer, or only to a limited extent, to the eye or on the display device. In particular the alternating current may be synchronized with the image frequency in such a way that a whole number of video images occurs in half a switching period.

It is understood that the aforementioned characteristics, and those yet to be elucidated, may be used not only in the specifically indicated combination but also in other combinations or individually, without departing from the context of the present invention.

Further aspects of the invention may be seen from the following description of a preferred embodiment and from the appended illustrations.

### BRIEF DESCRIPTION OF THE DRAWINGS

FIG. 1 is a preferred embodiment of an inventive device.

FIG. 2 is an alternative embodiment of a beam splitter used in an inventive device.

FIG. 3 is an inventive light source.

FIG. 4 is an additional embodiment of an inventive device;

FIG. 5 is an enlarged detail from FIG. 4.

### DETAILED DESCRIPTION OF THE INVENTION

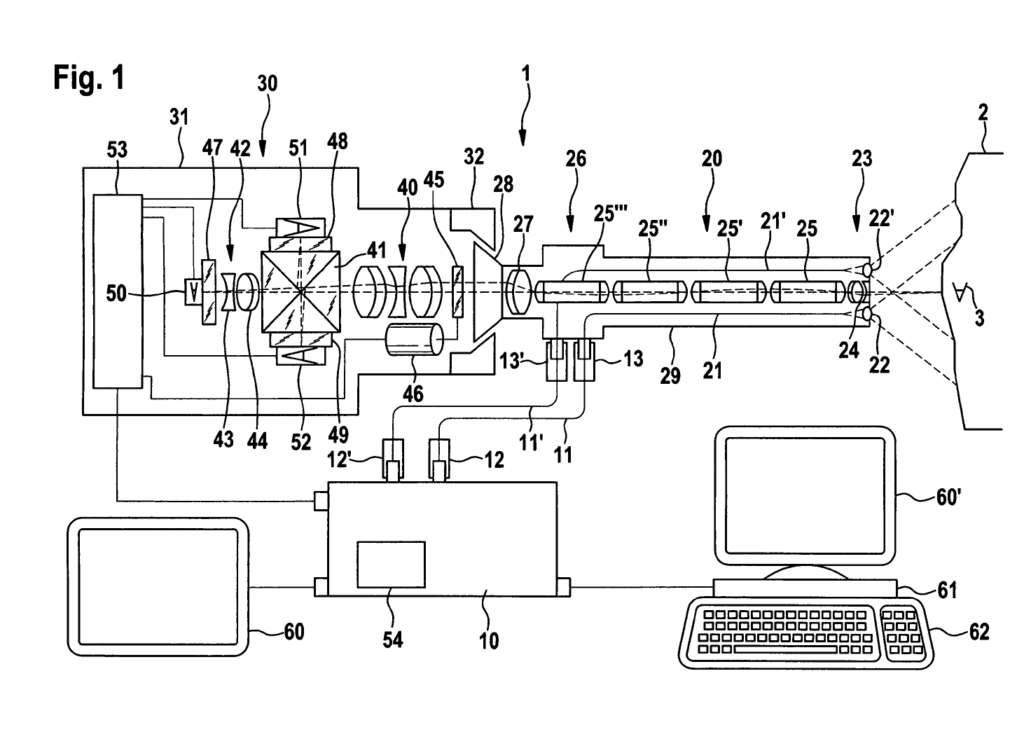

According to FIG. 1, an inventive apparatus 1 includes light source 10. In the illustrated preferred embodiment the light source is configured to generate a fluorescence excitation beam, modulated continuously, for instance in sinus shape, and a white light illumination.

For retransmitting both types of beam, light-conducting cables 11, 11′ are provided respectively, and may be connected by connections 12, 12′ with light source 10 and by connections 13, 13′ with endoscope 20. In a corresponding coupling or, for instance, in using a super continuum laser, both types of beams also may be retransmitted by a single light conductor. The light source may also be integrated into the endoscope.

The fluorescence excitation beam and the white light are conducted to object end 23 (the distal end, at a distance from the observer) of endoscope 20 by means of endoscope light conductors 21, 21′. Enlarging lenses 22, 22′ are positioned to serve to uniformly distribute the illumination ray onto the area to be examined, for instance an object 2, or a tissue area in an internal body cavity (not illustrated).

To generate an image of a partial area of object 2, endoscope 20 comprises endoscope lens 24. The intermediate image it generates is conducted by a relay lens system, here an arrangement of rod lenses 25, 25′, 25″, 25′″, to end 26 of endoscope 20 that is distant from the object (close to the observer or proximal). If, instead of illustrated rigid endoscope 20, a flexible endoscope is used, then the generated image may be transmitted by fiberglass image conductors. Ocular lens arrangement 27 is provided on the proximal end of the endoscope. As long as video camera arrangement 30 is not attached to endoscope 20, a direct view is possible through eyecup 28. Endoscope light conductors 21, 21′, endoscope lens 24, and relay lenses 25, 25′, 25″, 25′″ are thus incorporated in endoscope shaft 29 that may be inserted into a body opening.

For fluorescent imaging, video camera arrangement 30 may be attached to endoscope 20. Said arrangement contains in housing 31 one or more optical sensors as well as additional optical and possibly electronic components. For dissoluble connection with endoscope 20, endoscope coupling 32 is provided that, for instance, contains a snapping or bayonet mechanism in order to ensure a simple, secure and dissoluble connection. In particular, an abutment surface (not illustrated) may be provided in order to fix the relative position of endoscope and video camera arrangement, as well as an entry window (not illustrated) to prevent soiling of the video camera arrangement.

Video camera arrangement 30 contains camera lens 40, beam splitter configured as divider cube 41 for dividing the image into several image sensors, image sensors 50, 51, 52, and adjustment lens 42, here depicted summarily in image sensor 50. Adjustment lens 42 contains, for instance, a lens or set of lenses with negative diffractive power 43 and a lens or set of lenses with positive diffractive power 44 and is configured in such a way that, despite the different size, the same image field is displayed on the active surface of image sensor 50 as on image sensors 51 and 52. This is illustrated in FIG. 1 symbolically through depicted structure 3, which through the adaptive lens configured as a reduction lens, is configured on image sensor 50 smaller than on image sensors 51 and 52.

In addition, video camera arrangement 30 contains preparatory lenses 45, 47, 48, 49, which may be configured in particular as filters and/or as optical switches. The preparatory lenses may comprise, for instance, color filters, in particular absorption or interference filters, electronically tunable filters, prisms, extension plates, or spatial frequency filters (anti-aliasing filters). Thus, in particular, preparatory lens 45, which is mounted downstream of all image sensors, may be set to eliminate light portions that are undesired for all image sensors. Actuator 46, for instance for pivoting a filter in or out, may be connected with preparatory lens 45. Preparatory lenses 47, 48, 49 serve in particular to filter the incident light according to the particular type of sensor.

Thus, for instance, image sensor 50 may be configured as phase-sensitive solid state image sensor, which pixel by pixel registers the intensity of the incident fluorescent beam and the phase-displacement, that is, the time lapse between fluorescence excitation beam and incident fluorescent beam. From data supplied by this image sensor, it is possible to reconstruct a fluorescence lifetime image, a fluorescence intensity image, and/or 3D data.

In order for a fluorescence lifetime image to arise, it is advantageous to block off the primarily much brighter reflected or scattered fluorescence excitation beam. For this purpose, preparatory lens 47 may be configured, for instance, as bandpass or else as edge filter, which is non-permeable for the shortwave fluorescence excitation beam but allows the long-wave fluorescent beam to pass through. Through a corresponding evaluation, as indicated for instance in EP 1 746 410 A1, the phase displacement and thus the time lapse may be ascertained pixel by pixel. A fluorescence intensity image may be generated with the same image sensor and the same filter, but with the evaluation of the demodulation. If only a fluorescent imaging is intended, then the corresponding filter may be positioned also at another location in video camera arrangement 30 or else in the imaging beam path in endoscope 20.

With the same image sensor and the same evaluation as for the fluorescence lifetime image, it is also possible to generate 3D data, in particular pixel by pixel distance information. For this purpose a likewise continuously modulated illuminating beam may be used, which may also be the fluorescence excitation beam. To measure only the time lapse caused by the distance from the object, not the time delay caused by fluorescence, it is advantageous to select an illuminating beam that causes no significant fluorescence, that is, for instance a beam in the red or NIR range. It is not possible, however, to block off the fluorescent beam by a corresponding filter. As long as the fluorescent beam is essentially weaker than the reflected or scattered radiance or lies outside the detection range of the phase-sensitive image sensor, it is also possible to dispense with this. To improve the signal to noise ratio, the major part of a white light illumination may be blocked by a bandpass filter that is permeable for the modulated analytical light. Both filters, for fluorescence and for distance measurement may also be positioned so that they may be switched as preparatory lens 45 or 47.

Image sensor 51 generates an x-ray color image in an embodiment. Preparatory lens 48 may be configured, for instance, as IR blocking filter for this purpose. Image sensor 52 may, for example, generate an image in the NIR range, but could also, for instance, record a heat image or could contain an image reinforcer to increase sensitivity.

The preparatory lenses may also be configured as electronically controllable filters, for instance as liquid crystal tunable filters (LCTF) or as acousto-optical tunable filters (AOTF). The beam splitter may also be configured as spectral selective, for instance by a dichroitic coating, so that a smaller portion of the light is lost in blocking filters.

Image sensors 50, 51, 52 are connected with electronic control 53, which controls the image sensors and selects image data and, in some cases, after an initial pre-processing, retransmits such data. Electronic control 53 may be also connected with light source 10, so that the selection of data and the modulation of the fluorescence excitation beam may be synchronized. In addition, control apparatus 54 may be provided, which for instance may be integrated in light source 10. In addition, the invention provides display devices 60, 60′ to display image data, as well as an input device, for instance keyboard 62, touch screen, or else a speech recognition device.

Control apparatus 54 processes the image signals for immediate display, controls light source 10 synchronously with the image sensors, in some cases controls powerable filters, and conducts the image data onward to computer 61 for additional processing, display, and storage. In addition, control apparatus 54 or computer 61 is equipped with means for connecting or synoptic representation of the various image data, and in some cases for generating a synthetic stereo image.

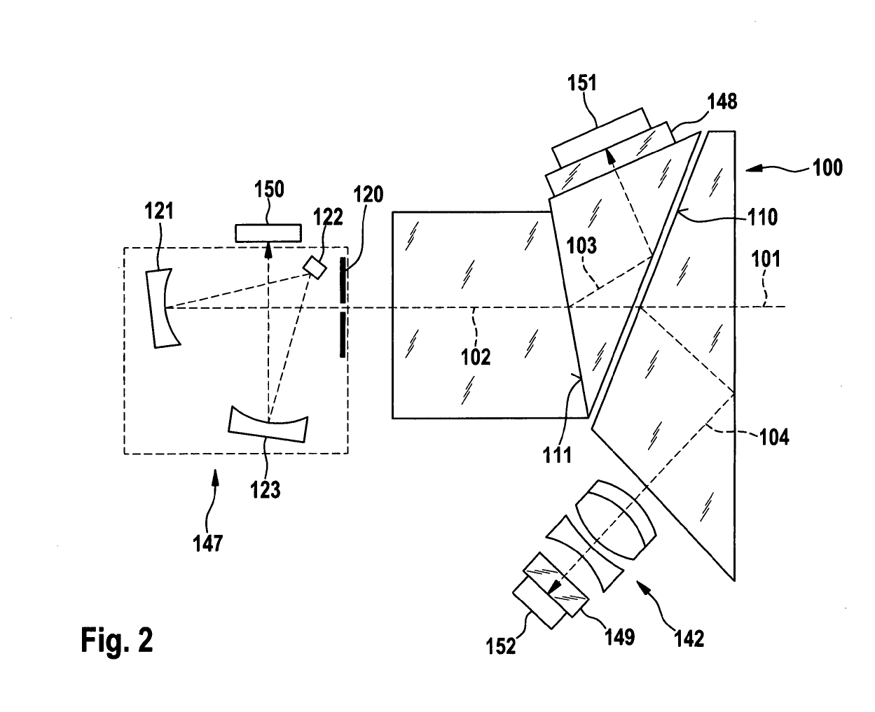

An alternative configuration of the beam splitter is shown in FIG. 2. Here, instead of beam divider cube 41, prisms are provided to divide the light, said prisms forming prism block 100.

Incident beam 101 is divided at two border surfaces 110 and 111 into a total of three channels 102, 103, and 104. These channels guide the light onto three image sensors 150, 151, 152, at least one of which may be a phase-sensitive image sensor. The incident intensity may be mirrored color-neutrally in predetermined intensity ratios in the individual channels under metallic coating, or under dichroitic coating may be broken down color-selectively or spectrally. By introducing additional surfaces, it is also possible to generate more channels, or by using a simple splitter prism just two channels.

Adaptive lens 142 may be placed before the image sensor 152 here, along with preparatory lens 149, for instance, a filter. The preparatory lens before image sensor 151 may also be filter 148, for instance. Crossed Czerny-Turner spectrometer 147 serves in this embodiment as the preparatory and adaptive lens before image sensor 150. The center image line, for instance, may be selected by line diaphragm 120 and imaged by first hollow mirror 121, diffraction grating 122, or else a diffractive optical element or a prism, and may be imaged by second hollow mirror 123 onto image sensor 150. As a result, a spectrally dissolved image, spatially dissolved in one dimension, may be generated. A complete image may be assembled in mosaic manner, in that the imaged line is directed over the object, for instance by pivoting the endoscope back and forth, which may be done manually or mechanically by a corresponding pivoting device, for instance with a rotating-view endoscope, or by automatic scanning by moving line diaphragm 120 and/or spectrometer 147. Corresponding control and evaluation software may be installed in the control apparatus for this purpose.

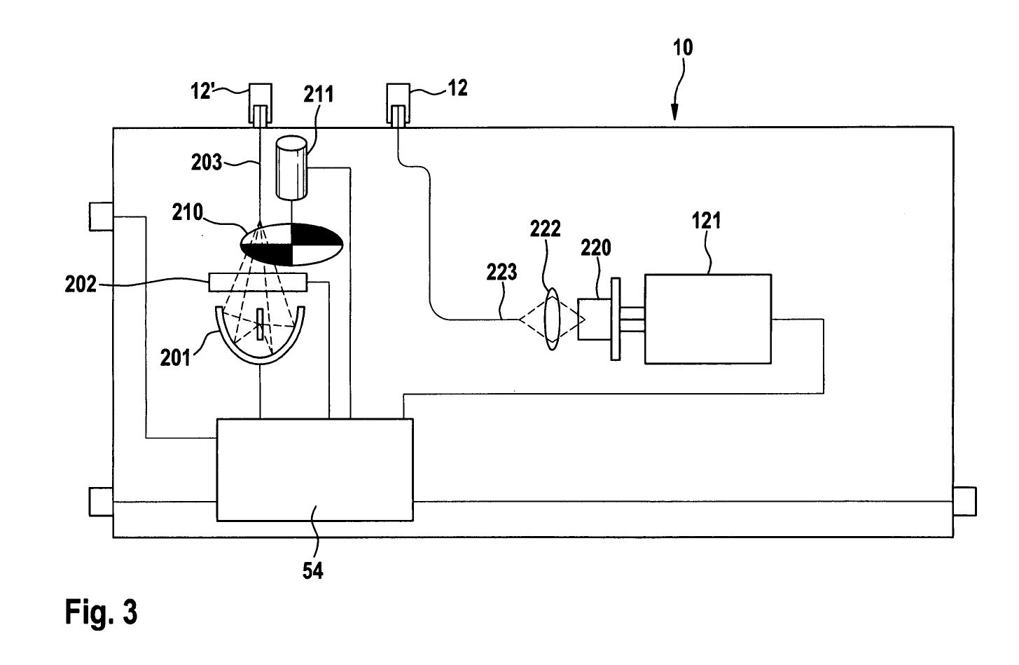

As shown in FIG. 3, according to the invention light source 10 may contain control apparatus 54 that communicates with electronic control 53, display devices such as display screen 60, and other devices such as computer 61, and for this purpose may be connected by plug-in connections. The control device, in addition, controls the light generation, for instance for white light and the fluorescence excitation beam.

For this purpose light source 10 contains as white light source metal-halide-arc discharge lamp 201, which may comprise a reflector, as well as other elements for collimation or coupling in light source 203. Alternatively, LED, xenon, or halogen lamps may be used as white light source. To prevent the white light from adversely affecting the fluorescent measurement, chopper wheel 210 may be provided, which interrupts the light flow as soon as a fluorescent measurement takes place. This may be entered manually in order to observe alternatively in white light and in fluorescent light, so that a fluorescence lifetime image (FLIM) or a fluorescence intensity image (AF/PDD) may be recorded. It is also possible to switch automatically, in particular in video pulse or a fraction thereof, between white light and fluorescent observation. The control apparatus controls power drive 211 of the chopper wheel corresponding to the particular requirements, for instance synchronously with the selection of the particular image sensor. Instead of a chopper wheel a pivot mirror or an electronically controlled filter may be used. In using solid state light sources, for instance LED or laser light sources, they may be powered directly in the corresponding pulse. Light conductor 203 conducts the light into a light conductor cable by way of connection 12′.

To generate the fluorescence excitation beam, laser diode 220 may be provided that is powered by drive electronics apparatus 221 and whose light is coupled by collimation lens 222 into light conductor 223. Alternatively, a fiber coupled light diode or a superluminescent diode may be used. The generated light may be conveyed into a light conductor cable by connection 12 to be retransmitted into the endoscope. The laser diode is modulated synchronously by the control apparatus to select the phase-sensitive image sensor.

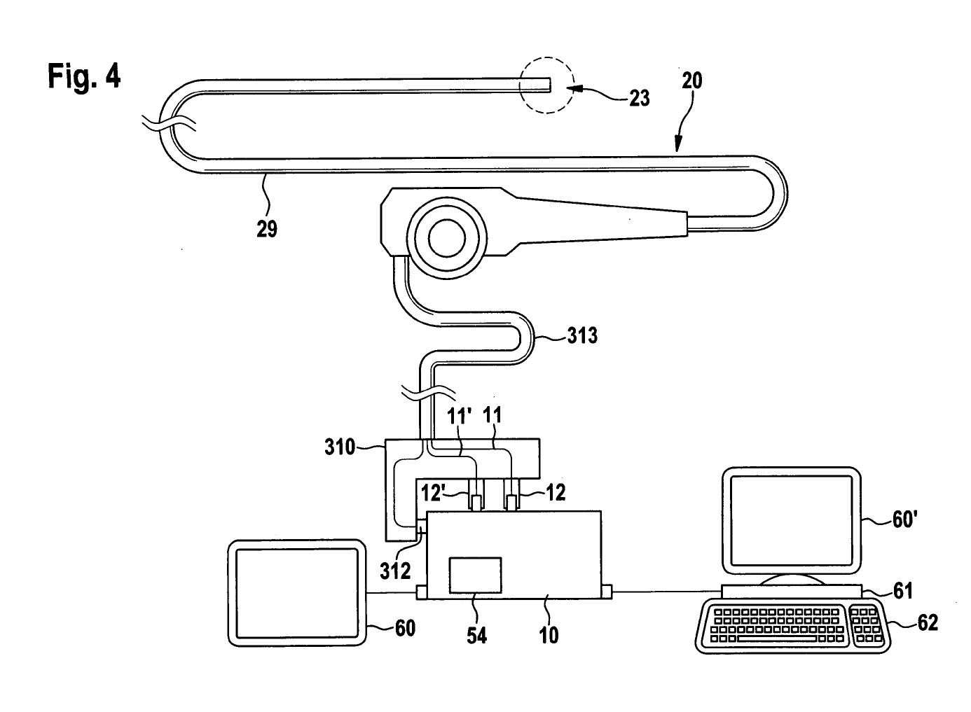

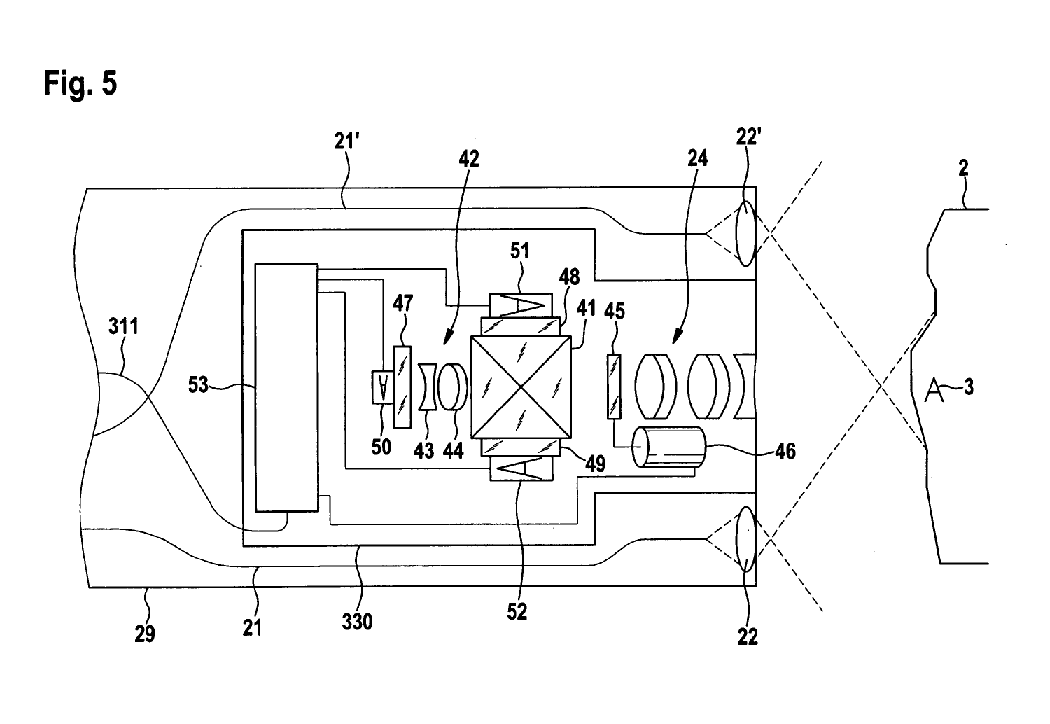

In the additional embodiment of the invention, shown in FIG. 4, the optical and electronic components, which in the embodiment illustrated in FIG. 1 are part of video camera arrangement 30, are positioned inside endoscope shaft 29 near its distal end 23 that is shown in detail in FIG. 5. Neither a relay lens system or fiberglass image conductor for retransmitting the image generated by the endoscope lens to the proximal end of the endoscope, nor an eyepiece is required here.

The endoscope lens 24 comprises the entirety of the lenses before beam splitter 41; no additional video camera lens is required. Preparatory lens 45, for instance an in-pivoting filter, may be positioned here, for instance, between endoscope lens 24 and beam splitter 41. Endoscope lens 24 and the components that make up video camera arrangement 30 may be combined into distal video camera unit 330, which may be dissolubly connected with the remaining part of endoscope 20 by a coupling (not illustrated) and may be exchangeable with other video camera units in the manner of an interchangeable head or interchangeable lens. Distal video camera unit 330 may also include the distal illuminating lens, in particular enlarging lenses 22, 22′ and parts of endoscope light conductors 21, 21′ associated with them, as well as the distal end of endoscope shaft 29.

Endoscope shaft 29 is flexible in this embodiment, but may also be semi-rigid or rigid. Electronic control 53 is connected with control apparatus 54 by cable 311 that is conveyed with light conductors cables 11, 11′ through endoscope shaft 29 and endoscope cable 314. To connect endoscope 20 with light source 10 and with control apparatus 54, connections 12, 12′ and connection 312 of cable 54 may be combined into connection box 310.

The structure of endoscope 20 advantageously corresponds to that of a standard videoscope. For descriptions of additional units, see FIG. 1.

If an inventive method for endoscopic FLIM diagnosis is employed, then ahead of time a photosensitizer may be attached to the patient or to the tissue area to be examined, for instance 5-amino levulinic acid, which causes the formation of fluorophores that may be excited to fluorescence. In an autofluorescence diagnosis, the previous application of photosensitizers is not necessary, although the fluorescence signal in this case is generally weaker than fluorescence induced by a photosensitizer. Depending on the bodily tissue and objective of the diagnosis, that is whether degraded cartilage, plaques, degenerative tissue or some other biological material is to be examined, the auto- or induced fluorescence is preferable, although a combination of the two methods is also possible.

Then, in some cases after corresponding preparation of the patient, endoscope 20 may be inserted into the body cavity in which the diagnosis is to take place, through a natural or artificial body opening. Video camera arrangement 30, unless it forms a unit with the endoscope or is already connected with it, is connected to endoscope 20, for instance by being clipped onto eyecup 28 by endoscope coupling 32. If light-generating means are not part of the endoscope, t light source 10 may be connected with endoscope 20 by light cables 11, 11′. Endoscope 20 is advantageously secured to a retainer, which prevents any motion by the endoscope relative to the examined object during the examination.

In order to apply the inventive method for fluorescent imaging, the illuminating light is generated in the light source, in particular the fluorescence excitation beam and white light. The fluorescence excitation beam comprises, in particular, wavelengths in the short-wave region of the visual spectrum or in near UV, because light of these wavelengths is well suited for the excitation of many fluorophores. In particular, this may be radiance of 405 nm or 445 nm generated by a super luminescent diode or a diode laser. The white light, for example, may embrace the entire visible spectrum or a part thereof, or may consist of one or more narrow-band portions. The fluorescence excitation beam is intensity-modulated with a frequency of, for instance, about 10 to 100 MHz in sinus shape. The white light may advantageously be switched in video pulse.

The white light and fluorescence excitation beam may be conducted onto the area to be examined by light cables 11,11′ and light conductors 21, 21′. A fluorescent image is generated by the imaging lens on phase-sensitive image sensor 50, so that preparatory lens 47 before image sensor 50 is configured as a longpass filter, which is completely or almost completely impermeable to the fluorescence excitation beam. By selecting the image sensor in a manner synchronized with the modulation of the fluorescence excitation beam, phase-dependent data are obtained and are processed by electronic control 53 and control apparatus 54 into intensity information and phase information. The control apparatus thereby generates a fluorescent phase image that constitutes the time lapse of the fluorescent ray with respect to the fluorescence excitation beam or fluorescence lifetime. A fluorescent intensity image may likewise be generated.

The FLIM (fluorescence lifetime image) may be displayed for the physician on a screen and remain available for further image processing steps or for storage. To improve the specificity of the diagnosis it is advantageous to include the fluorescent intensity image or else an x-ray image, which for this purpose may be depicted, for instance, as alternating with or superimposed on the fluorescence lifetime image.

It is also possible to take a 3D image of the examined area with the phase-sensitive image sensor. For this purpose the white light is modulated, for instance, in the same way as the fluorescence excitation beam, so that fluorescence excitation portions remaining in the light source 10 may be filtered out to avoid fluorescent radiation. The fluorescence excitation beam may also be used for this purpose, however, with the fluorescent beam being filtered out by means of a shortpass filter before image sensor 50. As a rule, however, the fluorescent beam will be so weak that it may cause no significant measurement error. The pixels are selected and the 3D data are evaluated in the same way as with the fluorescence lifetime image, with the difference that here only, or predominantly, reflected or scattered radiation is recorded, in which the time lapse constitutes the running period of the light owing to its distance. In this way 3D data may be generated that may likewise be displayed for the observer, for instance on a video screen.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

1. An apparatus for fluorescent imaging, consisting of:
a light-generating means for generating at least one modulated fluorescence excitation beam;
a light retransmitting means for retransmitting the fluorescence excitation beam onto an area that is to be examined, so that the light retransmitting means comprise at least one illuminating lens that can be used endoscopically;
a light imaging means for imaging a fluorescent beam from the area to be examined onto a first image sensor, which comprises a number of pixels, so that the light-imaging means comprise at least one imaging lens that can be used endoscopic ally; and
a control and evaluation means for controlling the light-generating means, to power the first image sensor, and to evaluate data supplied by the first image sensor to generate a fluorescent image, wherein;
the fluorescence excitation beam can be continuously modulated;
the first image sensor is a solid state detector, which can be powered phase-sensitively; and
the data supplied by the first image sensor contain phase information of the fluorescent beam pixel by pixel.

2. The apparatus according to claim 1, wherein the illuminating lens and the imaging lens are positioned in common shaft that can be employed endoscopically.

3. The apparatus according to claim 2, further comprising a video camera arrangement that contains at least the first image sensor and is dissolubly connected with the common shaft.

4. The apparatus according to claim 2, wherein the illuminating lens, the imaging lens, and the common shaft are parts of a standard endoscope.

5. The apparatus according to claim 1, wherein at least the imaging lens and the first image sensor are positioned inside, and close to the distal end of, a shaft that can be employed endoscopically.

6. The apparatus according to claim 1, wherein a coherence reduction function is provided.

7. The apparatus according to claim 1, further comprising at least one additional image sensor.

8. The apparatus according to claim 7, wherein the light-imaging means comprise a beam splitter or an optical switch, or a combination thereof.

9. The apparatus according to claim 8, further comprising an adjustment lens for adapting the visual field of the first image sensor and at least one additional image sensor.

10. The apparatus according to claim 8, wherein the at least one additional image sensor is provided to generate an image by means of the reflected or scattered light, or both.

11. The apparatus according to claim 10, wherein the image generated by means of the reflected or scattered light, or both, is spectrally dissolved or selected.

12. The apparatus according to claim 11, wherein the spectrally selected image is obtained through point or line scanning.

13. The apparatus according to claim 7, wherein the at least one additional image sensor is provided for generating a fluorescent intensity image.

14. The apparatus according to claim 1, wherein the apparatus is configured for generating 3D data.

15. The apparatus according to claim 14, wherein the control and evaluation means are configured to correct the fluorescence lifetime data by using the 3D data.

16. The apparatus according to claim 14, wherein the 3D data can be evaluated for measuring surfaces or volumes, or both.

17. The apparatus according to claim 14, wherein a stereo image is synthesized from the 3D data.

18. The apparatus according to claim 7, wherein the control and evaluation means are configured to generate a synoptic depiction of the data supplied by the first image sensor and the at least one additional image sensor.

19. The apparatus according to claim 1, wherein the light-generating means are provided for generating at least one additional illuminating beam.

20. The apparatus according to claim 1, wherein the first image sensor is a solid state detector which can be powered phase-sensitively and the data supplied by the first image sensor contain pixel by pixel phase information on the fluorescence exitation beam.

21. A method for fluorescent imaging comprising the following steps:
generating at least one modulated fluorescence excitation beam;
retransmitting the fluorescence excitation beam onto an area that is to be examined by at least one illuminating lens that can be employed endoscopically;
imaging the fluorescence exitation beam from the area to be examined onto at least a first image sensor, which comprises a number of pixels, by at least one imaging lens that can be employed endoscopically; and
generating of a fluorescent image through evaluation of the data supplied by the first image sensor, characterized in that:
the fluorescence excitation beam is continuously modulated;
the first image sensor is a solid state detector that is powered phase-sensitively; and
the data supplied by the first image sensor contain pixel by pixel phase information on the fluorescent beam, from which a fluorescence lifetime image is generated.
